(19) United States
(12) Patent Application Publication
(10) Pub. No.: US 2026/0148705 A1
(43) Pub. Date: May 28, 2026

(54) DISPLAY DEVICE

(71) Applicant: Sharp Display Technology Corporation, Kameyama City (JP)

(72) Inventors: Shinya NAKAJIMA, Kameyama City (JP); Keisuke KANDA, Kameyama City (JP)

(21) Appl. No.: 19/396,768

(22) Filed: Nov. 21, 2025

(30) Foreign Application Priority Data
Nov. 27, 2024 (JP) 2024-206248

(51) Int. Cl. G09G 3/34

(52) U.S. Cl. CPC G09G 3/3406; G09G 2320/0626; G09G 2320/0686; G09G 2360/144; G09G 2360/16

(57) ABSTRACT

A display device includes a display panel having a display surface, an image display unit configured to display an image on the display surface according to gradation information included in image data supplied from an external source, an illumination device having a plurality of light sources, a light source drive unit configured to drive the plurality of light sources according to brightness information included in the image data, an illuminance sensor configured to output a detection signal according to the amount of detected ambient light, and a controller. The controller corrects the brightness information according to the detection signal, controls the light source drive unit such that the plurality of light sources are driven according to the corrected brightness information, corrects the gradation information according to the detection signal, and controls the image display unit such that an image is displayed according to the corrected gradation information.

### BACKGROUND

### 1. Field

The technology disclosed in this specification relates to a display device with increased display quality.

### 2. Description of the Related Art

As an example of display devices, a display device described in Japanese Unexamined Patent Application Publication No. 2012-220717 is known. Japanese Unexamined Patent Application Publication No. 2012-220717 describes an image processing apparatus (image processing IC) that processes signals for displaying images on a display device. The image processing IC described in Japanese Unexamined Patent Application Publication No. 2012-220717 includes a luminance correction unit that performs luminance correction on an input image to produce an output image, a luminance average value calculation unit that calculates a luminance average value of the output image, a luminance average value calculation unit that calculates a luminance average value of the input image, a selector, a difference calculation unit that calculates a difference between the luminance average values, a duty value calculation unit that determines a duty value based on the luminance average value or the difference value, a resister that stores a table used for determining the duty value, a duty value calculation unit that calculates a duty value for an input PWM signal, and a corporative processing unit to which a plurality of control signals representing the duty values are input and determines a duty value for an output PWM signal based on the duty values represented by both control signals.

The image processing apparatus described in Japanese Unexamined Patent Application Publication No. 2012-220717 performs a predetermined luminance conversion process on input image data to produce output image data, and displays images according to the output image data. However, the luminance conversion processing does not reflect detection signals detected by an illuminance sensor. Accordingly, if images are displayed by using the light from a backlight that reflects detection signals detected by the illuminance sensor, images of colors different from the original colors may be displayed, resulting in poor display quality.

The technology described in this specification has been made under the above-described circumstances, and made to achieve increased display quality.

### SUMMARY

A display device according to the technology described in the specification includes a display panel having a display surface, an image display unit configured to display an image on the display surface according to gradation information included in image data supplied from an external source, an illumination device having a plurality of light sources and is configured to emit light used for display to the display panel, a light source drive unit configured to drive the plurality of light sources according to brightness information included in the image data, an illuminance sensor configured to detect ambient light and output a detection signal according to the amount of detected ambient light, and a controller. The controller corrects the brightness information according to the detection signal, controls the light source drive unit such that the plurality of light sources are driven according to the corrected brightness information, corrects the gradation information according to the detection signal, and controls the image display unit such that an image is displayed according to the corrected gradation information.

### BRIEF DESCRIPTION OF THE DRAWINGS

FIG. 1 is a schematic side view of a liquid crystal display device according to a first embodiment;

FIG. 2 is a cross-sectional view of a liquid crystal panel of the liquid crystal display device and a backlight device according to the first embodiment;

FIG. 3 is a plan view of an LED substrate in the backlight device according to the first embodiment;

FIG. 4 is a plan view of pixel arrays in the liquid crystal panel according to the first embodiment;

FIG. 5 is a plan view illustrating a relationship between dimming areas defined in a display area of the liquid crystal panel and LEDs according to the first embodiment;

FIG. 6 is a plan view of unit pixels in the dimming area according to the first embodiment;

FIG. 7 is a block diagram of an electric configuration of the liquid crystal display device according to the first embodiment;

FIG. 8 is a plan view illustrating a relationship between a first area and a second area, and a relationship between first LEDs and second LEDs in a display area according to the first embodiment;

FIG. 9 is a first data table according to the first embodiment;

FIG. 10 is a second data table according to the first embodiment; and

FIG. 11 is a flowchart illustrating a correction process to be performed by a controller according to the first embodiment.

### DESCRIPTION OF THE EMBODIMENTS

### First Embodiment

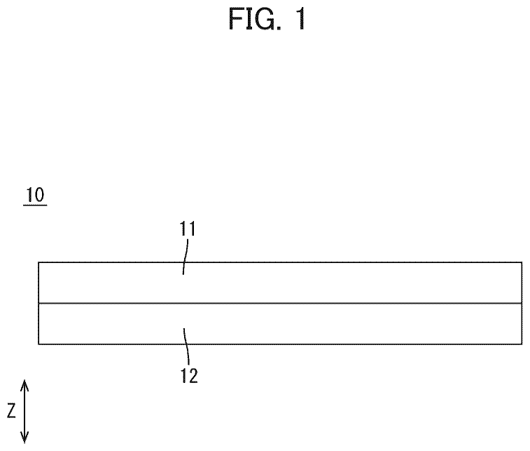

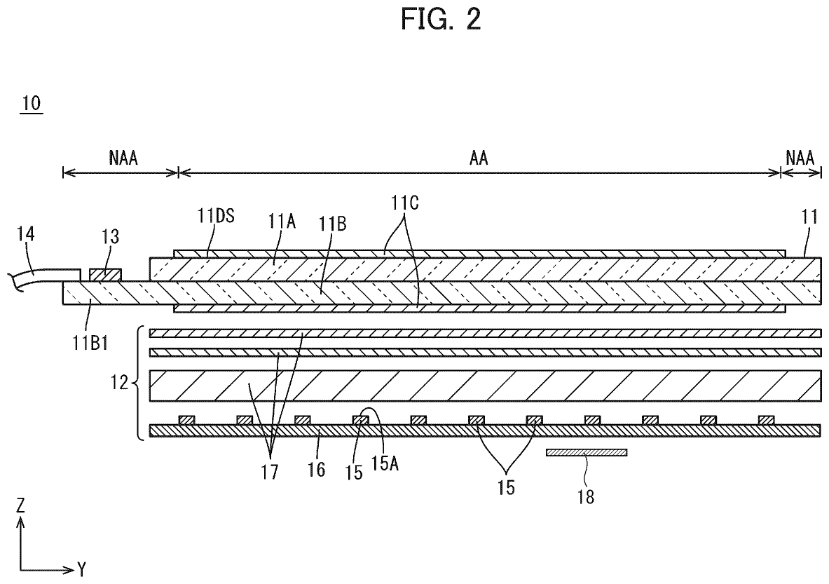

The first embodiment will be described with reference to FIG. 1 to FIG. 11. In this embodiment, a liquid crystal display device (display device) 10 will be described as an example. The X-axis, Y-axis, and Z-axis are shown in some drawings, and each axis direction corresponds to the direction indicated in each drawing. In FIG. 1 and FIG. 2, the upper side denotes the front side and the lower side denotes the rear side.

As illustrated in FIG. 1, the liquid crystal display device 10 includes a liquid crystal panel (display panel) 11 that displays images, and a backlight device (illumination device) 12 that are disposed on the rear side (back side) of the liquid crystal panel 11 to emit light used for display to the liquid crystal panel 11. The liquid crystal panel 11 and the backlight device 12 are held by a predetermined holding member in a state in which the liquid crystal panel 11 and the backlight device 12 are stacked on the front side and on the rear side.

As illustrated in FIG. 2, the liquid crystal panel 11 is disposed on the front side (light output side) with respect to the backlight device 12. The liquid crystal panel 11 includes a pair of substrates 11A and 11B that are bonded together, and a liquid crystal layer (not illustrated) that are sealed between the pair of substrates 11A and 11B. Of the pair of substrates 11A and 11B, the front side (front surface side) is an opposite substrate 11A, and the rear side (rear surface side) is an array substrate 11B. An alignment film is disposed on each inner surface of the opposite substrate 11A and the array substrate 11B. In addition, a pair of polarizing plates 11C are disposed on outer surfaces of the opposite substrate 11A and the array substrate 11B.

As illustrated in FIG. 2, in the liquid crystal panel 11, a display area AA is a central portion of a display surface 11DS on which images are displayed. In the liquid crystal panel 11, a non-display area NAA is an outer peripheral portion that surrounds the display area AA in the display surface 11DS, and images are not displayed in the non-display area NAA. The array substrate 11B is larger than the opposite substrate 11A, and has a protruding portion 11B1 that extends laterally relative to the opposite substrate 11A. The protruding portion 11B1 is exposed without being covered by the opposite substrate 11A. The entire of the protruding portion 11B1 is the non-display area NAA, and on which a driver (image display unit) 13 and a flexible substrate 14 for supplying various signals are mounted. The driver 13 includes an LSI chip that includes an internal drive circuit, and processes various signals that are transmitted via the flexible substrate 14. The driver 13 supplies processed signals (including image signals) to the liquid crystal panel 11. The driver 13 is mounted on the protruding portion 11B1 of the array substrate 11B by Chip On Glass (COG) mounting. The flexible substrate 14 has a structure in which a plurality of wiring patterns are formed on a base material comprising a synthetic resin material (e.g., a polyimide resin) having insulating properties and flexibility. The flexible substrate 14 is connected at one end to the protruding portion 11B1 of the array substrate 11B and at the other end to a control board 18, which will be described in detail below. Various signals supplied from the control board 18 are transmitted to the liquid crystal panel 11 via the flexible substrate 14, processed by the driver 13 in the non-display area NAA, and output to the display area AA. The control board 18 is disposed on the rear side (side opposite to the liquid crystal panel 11) with respect to the backlight device 12 to overlap the backlight device 12.

As illustrated in FIG. 2, the backlight device 12 is a so-called direct backlight device and a main surface (main light-emitting surface) from which light is emitted faces a main surface of the liquid crystal panel 11 on the rear side. In the main light-emitting surface of the backlight device 12, a central portion that overlaps the display area AA of the liquid crystal panel 11 in plan view is a light-emitting area from which light is emitted. In the main light-emitting surface of the backlight device 12, an outer peripheral portion that overlaps the non-display area NAA of the liquid crystal panel 11 in plan view is a non-light-emitting area from which hardly any light is emitted. The backlight device 12 includes at least a plurality of light-emitting diodes (LEDs) 15, which are a light source, an LED substrate (light source substrate) 16 on which the plurality of LEDs 15 are disposed, and an optical member 17 that applies an optical effect to the light emitted by the LEDs 15.

The LEDs 15 are mounted on the LED substrate 16 by surface mounting as illustrated in FIG. 2. The LED 15 is a so-called top-emitting LED that has a light-emitting surface 15A from which light is emitted and the light-emitting surface 15A is a side (front side, optical member 17 side) opposite to the LED substrate 16. An optical axis of the LED 15 is aligned with the Z-axis direction. The “optical axis” here is an axis that aligns with an optical path of the light with the highest (peak) light emission intensity among the light emitted from the LED 15. In this embodiment, a white LED that emits white light that appears white as a whole is used as the LED 15.

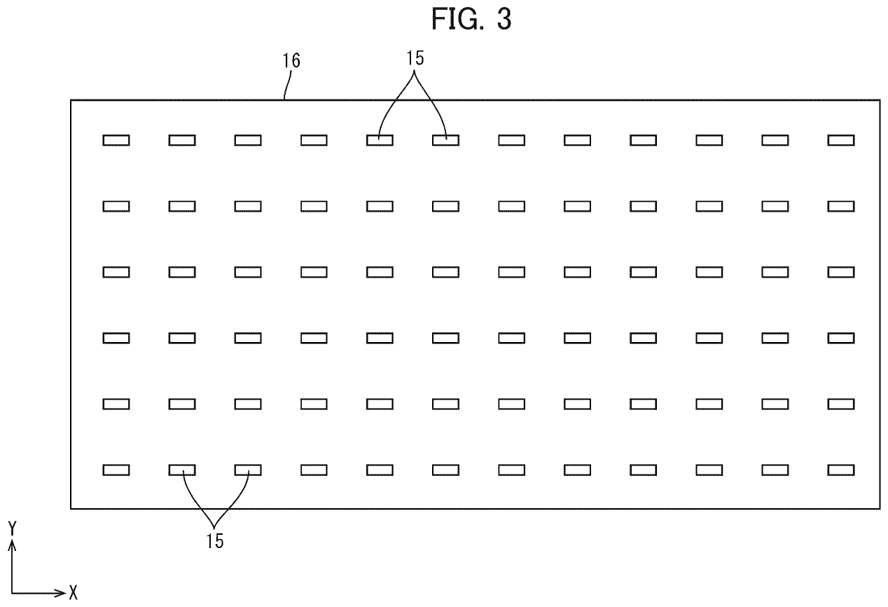

As illustrated in FIG. 2 and FIG. 3, the LED substrate 16 is a plate-shaped or film-shaped substrate that has main surfaces that are parallel to the main surface of the liquid crystal panel 11. A plurality of LEDs 15 are surface-mounted on the main surface of the LED substrate 16, which is one of the pair of main surfaces and faces the front side, and this main surface is the mounting surface. The plurality of LEDs 15 are disposed at intervals in the X-axis direction and in the Y-axis direction in the main surface on the front side of the LED substrate 16. The plurality of LEDs 15 may be arranged in a matrix pattern or in a staggered pattern. The LED substrate 16 is connected to the control board 18 via a connection member such as a flexible printed circuit (FPC). A drive signal for driving the LEDs 15 is to be supplied from the control board 18 via the connection member to the LED substrate 16.

As illustrated in FIG. 2, the optical member 17 is a plate-shaped or sheet-shaped member that has main surfaces that are parallel to the main surfaces of the liquid crystal panel 11 and the LED substrate 16. The front side of the optical member 17 is spaced apart in the Z-axis direction from the LEDs 15. The optical member 17 has a function of allowing the light emitted from the LEDs 15 to pass through to the liquid crystal panel 11 while applying a predetermined optical effect to the light. In FIG. 2, the optical member 17 comprises three sheets that are stacked. These three sheets of the optical member 17 include a diffusion plate, a prism sheet, a diffusion sheet, or the like. Such diffusion plate and diffusion sheet have a function of diffusing incident light and outputting the light. The prism sheet has a function of collecting incident light and outputting the light.

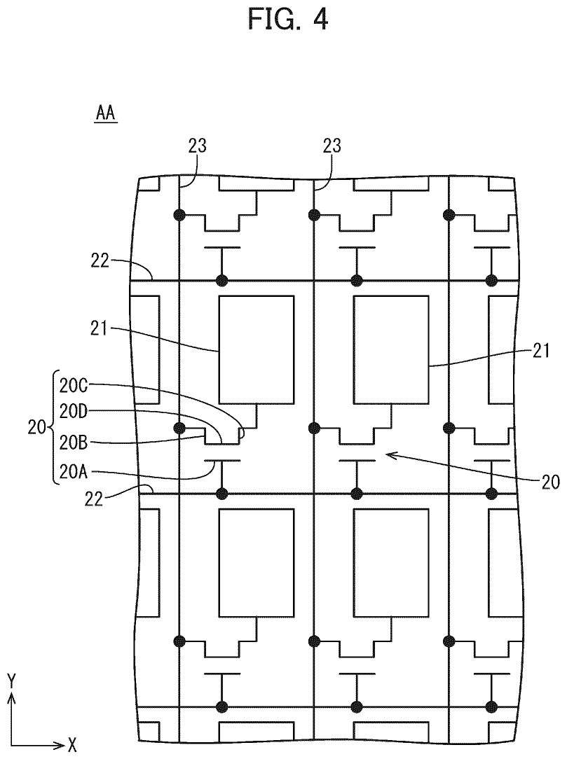

Next, a structure of the display area AA in the array substrate 11B of the liquid crystal panel 11 will be described with reference to FIG. 4. On the inner surface side of the array substrate 11B in the display area AA, as illustrated in FIG. 4, at least TFTs (transistors, switching elements) 20 and pixel electrodes 21 are provided. The plurality of TFTs 20 and the plurality of pixel electrodes 21 are spaced apart in the X-axis direction and in the Y-axis direction in a matrix (rows and columns) pattern. Around these TFTs 20 and pixel electrodes 21, gate wiring lines (scanning lines) 22 and source wiring lines (image lines, signal lines) 23 that are orthogonal (intersect) to each other are provided. The gate wiring lines 22 extend in the X-axis direction and the plurality of gate wiring lines 22 are spaced apart in the Y-axis direction. Scanning signals are to be supplied from the driver 13 or a circuit unit that is provided in the array substrate 11B to the plurality of gate wiring lines 22. The source wiring lines 23 extend in the Y-axis direction and the plurality of source wiring lines 23 are spaced apart in the X-axis direction. Image signals containing gradation information are to be supplied from the driver 13 to the plurality of source wiring lines 23. The TFT 20 includes a gate electrode 20A, which is connected to the gate wiring line 22, a source electrode 20B, which is connected to the source wiring line 23, a drain electrode 20C, which is connected to the pixel electrode 21, and a semiconductor portion 20D, which is connected to the source electrode 20B and the drain electrode 20C and comprises a semiconductor material. The TFT 20 is driven according to a scanning signal supplied to the gate electrode 20A by the gate wiring line 22. This scanning signal includes a potential higher than a threshold voltage of the TFT 20. With this scanning signal, a channel region is generated in the semiconductor portion 20D, thereby enabling electric charge to move between the source electrode 20B and the drain electrode 20C via the channel region. Accordingly, the potential according to an image signal supplied to the source electrode 20B via the source wiring line 23 is supplied to the drain electrode 20C via the semiconductor portion 20D. As a result, the pixel electrode 21 is charged to the potential according to the image signal. The pixel electrode 21 is disposed in an area surrounded by the gate wiring lines 22 and the source wiring lines 23, and has a planar shape, for example, an elongated substantially rectangular shape. In the display area AA in the opposite substrate 11A, a plurality of color filters are disposed at positions facing the pixel electrodes 21 on the array substrate 11B side. These color filters provide unit pixels, which are display units described below, together with opposite pixel electrodes 21. On each of the innermost surfaces (uppermost layers) of the substrates 11A and 11B that are in contact with the liquid crystal layer, an alignment film (not illustrated) is formed to align the liquid crystal molecules contained in the liquid crystal layer.

It should be noted that the array substrate 11B may be provided with a common electrode that overlaps all pixel electrodes 21 via an insulating layer. The orientation state of liquid crystal molecules contained in the liquid crystal layer can be controlled by using an electric field generated between the common electrode and each pixel electrode 21. When such a common electrode is provided to the array substrate 11B, the display mode of the liquid crystal panel 11 may be the In-Plane Switching (IPS) mode, the fringe field switching (FFS) mode, or other modes. Alternatively, opposite electrodes that overlap all pixel electrodes 21 via the liquid crystal layer and the alignment film may be provided on the inner surface side of the opposite substrate 11A. The orientation state of liquid crystal molecules contained in the liquid crystal layer can be controlled by using an electric field generated between the opposite electrodes and each pixel electrode 21. When such opposite electrodes are provided to the opposite substrate 11A, the display mode of the liquid crystal panel 11 may be the IPS mode, the FFS mode, the Vertical Alignment (VA) mode, the Twisted Nematic (TN) mode, or other modes.

In the liquid crystal display device 10 having such a structure, the main surface of the liquid crystal panel 11 on the rear side is irradiated with planar light emitted from the plurality of LEDs 15 provided in the backlight device 12, as illustrated in FIG. 2. In the liquid crystal panel 11, when scanning signals are supplied sequentially to the plurality of gate wiring lines 22, the plurality of TFTs 20 connected to each gate wiring line 22 are driven sequentially. When image signals are sequentially supplied to the plurality of source wiring lines 23 in synchronization with the timing at which the scanning signals are supplied to each gate wiring line 22, the pixel electrodes 21 connected to the driven TFTs 20 are charged to a potential according to the image signal. The orientation state of the liquid crystal molecules is controlled according to the electric field generated between each pixel electrode 21 and the common electrode or opposite electrode, thereby the amount of light transmitted through the liquid crystal panel 11 can be controlled for each unit pixel. As a result, a predetermined image is displayed in the display area AA of the liquid crystal panel 11.

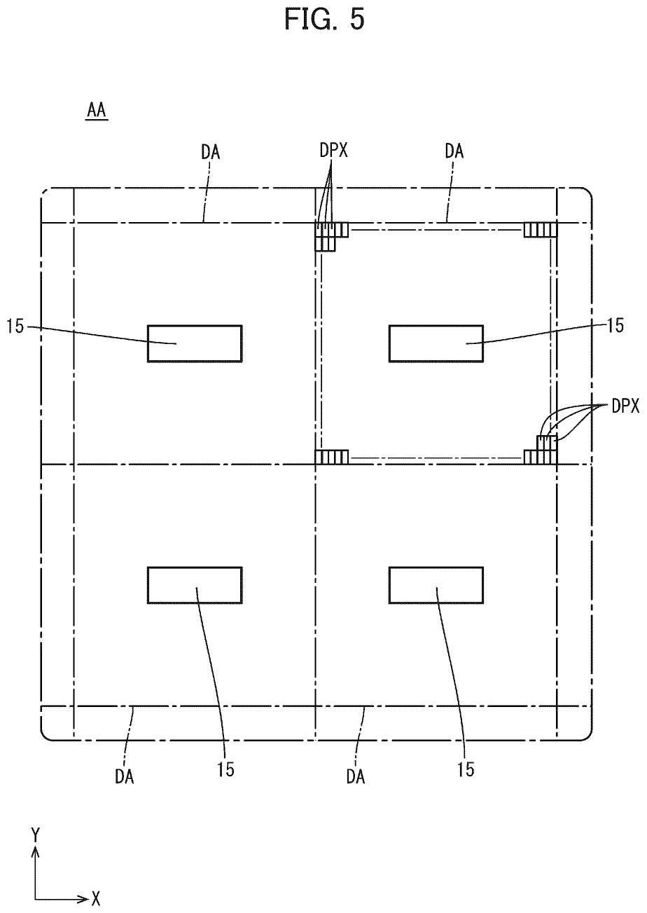

In the liquid crystal display device 10 according to the embodiment, so-called local dimming control is performed. Local dimming control is a method of increasing the contrast ratio of a displayed image or the like by adjusting the amount of light emitted by the plurality of LEDs 15 provided in the backlight device 12 according to the brightness of the image displayed in the display area AA of the liquid crystal panel 11 or by performing other processes. More specifically, for example, when an image displayed in the display area AA of the liquid crystal panel 11 includes a bright area and a dark area, the amounts of light emitted by the LEDs 15 that supply light to the bright area among the plurality of LEDs 15 are increased, whereas the amounts of light emitted by the LEDs 15 that supply light to the dark area are reduced or set to zero. To perform such local dimming control, first, the display area AA is divided into a plurality of dimming areas (segment areas, division areas) DA, as illustrated in FIG. 5. These dimming areas DA are provided in the X-axis direction and in the Y-axis direction in a matrix pattern of rows and columns in the main surface of the liquid crystal panel 11. Light is emitted from the plurality of LEDs 15 provided in the backlight device 12 to the plurality of dimming areas DA respectively. In this embodiment, to one dimming area DA, light is emitted from one LED 15. More specifically, to a dimming area DA, light may be emitted from a plurality of LEDs 15; however, light from one LED 15 that is disposed specifically for the dimming area DA is dominant in the amount of light emitted to the dimming area DA. The dimming area DA has a rectangular shape in plan view, and light from one LED 15 that is disposed at a central portion in the dimming area DA is mainly emitted to the dimming area DA. In other words, the dimming area DA is set to cover the area that overlaps the LED 15 and the surrounding area. Accordingly, in this embodiment, the plurality of LEDs 15 are individually provided for the corresponding plurality of dimming areas DA, and by controlling the drive of the unit pixels in each dimming area DA and each LED 15 provided for each dimming area DA, the local dimming control can be implemented.

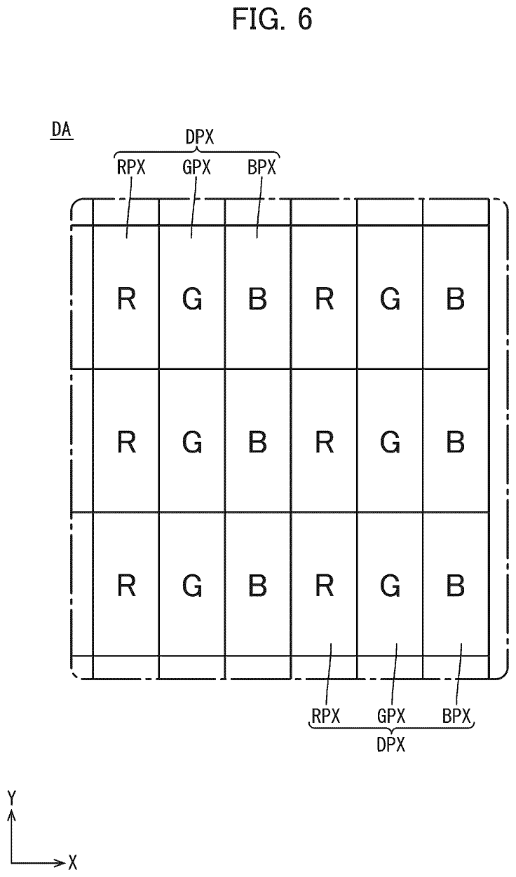

As illustrated in FIG. 5 and FIG. 6, a plurality of unit pixels are provided in the dimming area DA. These unit pixels will be described in detail. The color filters provided in the display area AA in the opposite substrate 11A have three colors of R (red), G (green), and B (blue) and are arranged and repeated in a predetermined order in the X-axis direction. Each color filter has a band-like shape extending in the Y-axis direction. These color filters of three colors, together with the pixel electrodes 21, provide red pixels RPX, green pixels GPX, and blue pixels BPX, which are unit pixels. FIG. 6 illustrates colors provided by the unit pixels as the letters, “R”, “G”, and “B”. These three unit pixels of the red pixels RPX, the green pixels GPX, and the blue pixels BPX provide display pixels DPX that enable color display of predetermined gradation. In the dimming area DA, these display pixels DPX are disposed in the X-axis direction and in the Y-axis direction in a matrix pattern of rows and columns. It should be noted that a light-shielding section (black matrix) is provided to separate each color filter to suppress the occurrence of color mixing in the display area AA in the opposite substrate 11A.

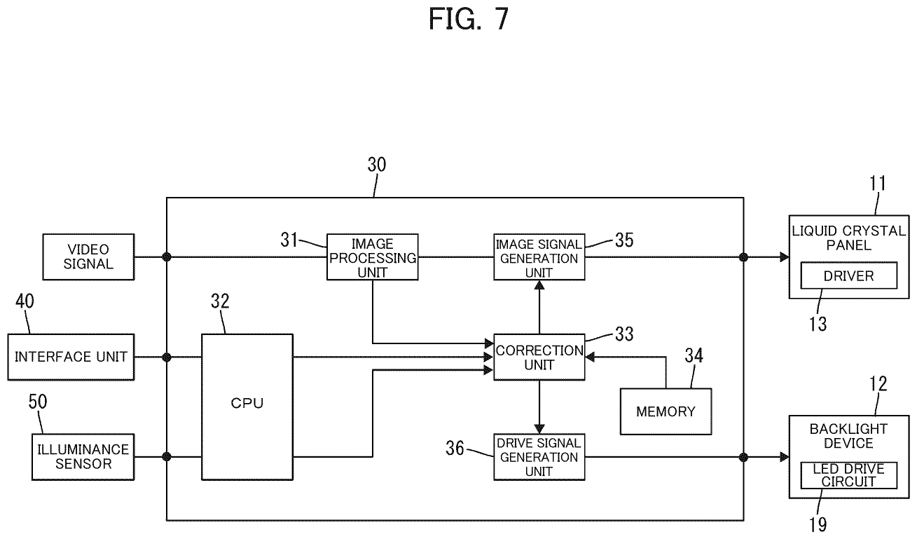

Next, an electric configuration in the liquid crystal display device 10 will be described with reference to FIG. 7. The liquid crystal display device 10 includes a controller 30 that controls the driving of the liquid crystal panel 11 and the backlight device 12, an interface unit 40, and an illuminance sensor 50, as illustrated in FIG. 7. The user of the liquid crystal display device 10 can input desired information to the liquid crystal display device 10 via the interface unit 40. The illuminance sensor 50 can detect ambient light around the liquid crystal display device 10 and output a detection signal that corresponds to the amount of detected ambient light. The controller 30 can perform local dimming control according to a detection signal from the illuminance sensor 50. In addition, various settings related to local dimming control performed using the controller 30 can be changed and adjusted as appropriate by the user of the liquid crystal display device 10 via the interface unit 40. The controller 30 is disposed in the control board 18 illustrated in FIG. 2.

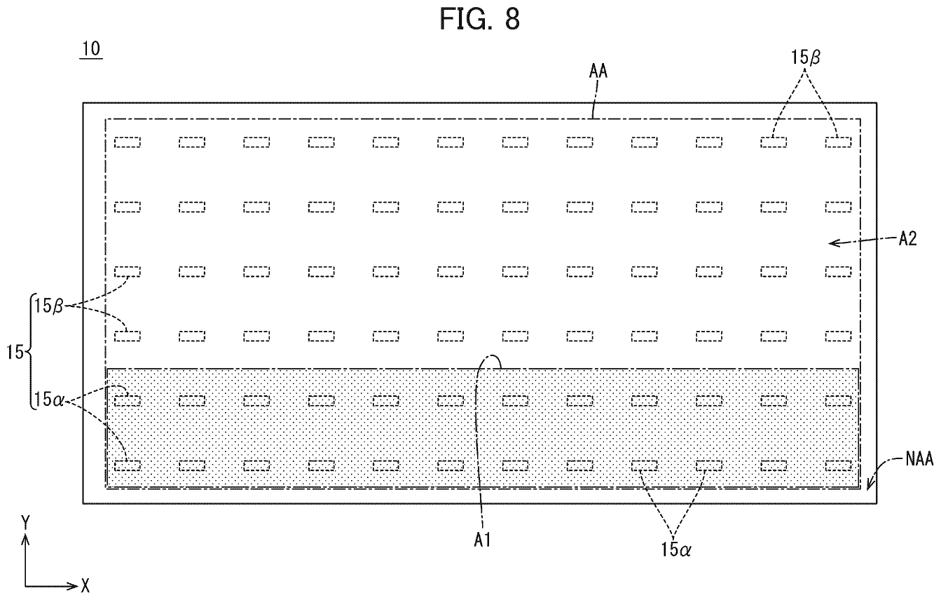

The controller 30 includes an image processing unit 31, a CPU 32, a correction unit 33, memory 34, an image signal generation unit 35, and a drive signal generation unit 36, as illustrated in FIG. 7. The image processing unit 31 processes video signals (image data) supplied from an external host system (external source) and outputs the processed video signals to the correction unit 33 and the image signal generation unit 35. The processed video signals output from the image processing unit 31 include display gradation information that is gradation information on images to be actually displayed in the display area AA. The display gradation information will be described in detail below. The CPU 32 can control the operation of the correction unit 33. When an instruction is input to the interface unit 40 by the user, the CPU 32 controls the operation of the correction unit 33 according to the instruction. Instructions input to the interface unit 40 may include, for example, an instruction to perform local dimming control for a specific area (hereinafter, referred to as a first area A1) in the display area AA and an instruction not to perform local dimming control for the other area (hereinafter, referred to as a second area A2), as illustrated in FIG. 8. More specifically, for example, when the liquid crystal display device 10 is used as an indicator in a passenger car, an area for displaying important safety-related information (e.g., warnings) is designated as the first area A1 via the interface unit 40, and an area for displaying other information (e.g., information that is less important than that in the first area A1) is designated as the second area A2. Each of the first area A1 and the second area A2 illustrated in FIG. 8 includes a plurality of dimming areas DA illustrated in FIG. 5. It should be noted that such settings for the first area A1 and the second area A2 may be designated via the interface unit 40, or may be set as default settings in advance in the manufacturing stage.

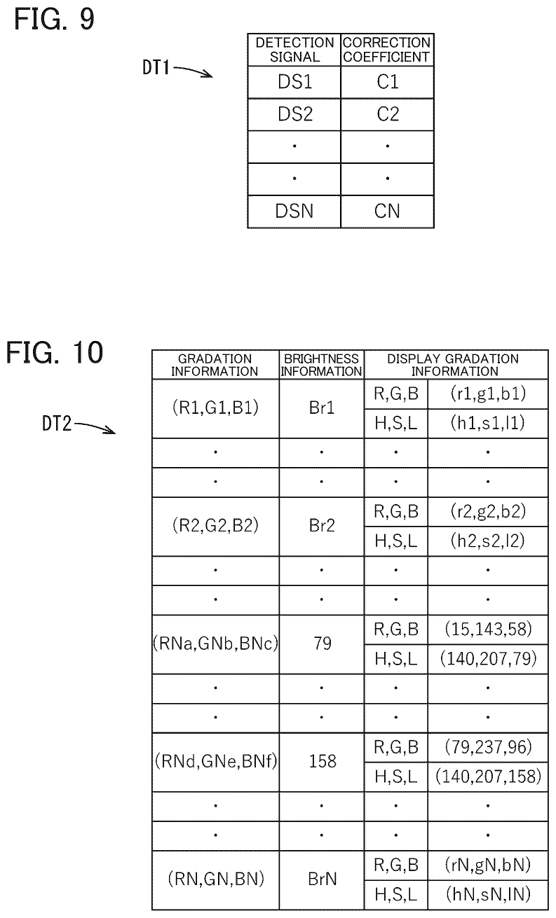

When a detection signal output from the illuminance sensor 50 is input, the CPU 32 controls the operation of the correction unit 33 according to the detection signal, as illustrated in FIG. 7. The correction unit 33 is controlled by the CPU 32 to correct processed video signals that are output from the image processing unit 31. Local dimming control is implemented by the correction of video signals by the correction unit 33. The correction unit 33 can use information stored in the memory 34 when correcting processed video signals. Specific correction processing to be performed by the correction unit 33 will be described in detail below. The memory 34 stores information such as data tables DT1 and DT2 illustrated in FIG. 9 and FIG. 10. The contents of the data tables DT1 and DT2 will be described in detail below. The image signal generation unit 35 generates image signals according to instructions from the correction unit 33 and outputs the image signals to a timing controller (not illustrated). An image signal is supplied to the driver 13 in the liquid crystal panel 11 at a predetermined timing by the timing controller. The drive signal generation unit 36 generates a drive signal for driving the LEDs 15 according to an instruction from the correction unit 33 and outputs the generated drive signal to an LED drive circuit (light source drive unit) 19 in the backlight device 12. The drive signal generated in the drive signal generation unit 36 is, for example, a pulse width modulation (PWM) signal. A PWM signal includes an ON period (turn-on period) and an OFF period (turn-off period), and the light emission of the LEDs 15 is controlled such that the amount of light to be emitted corresponds to a duty ratio that is a time ratio between the ON period and the OFF period. The LED drive circuit 19 drives each LED 15 according to an input drive signal such that each of the LEDs 15 emits a predetermined amount of light.

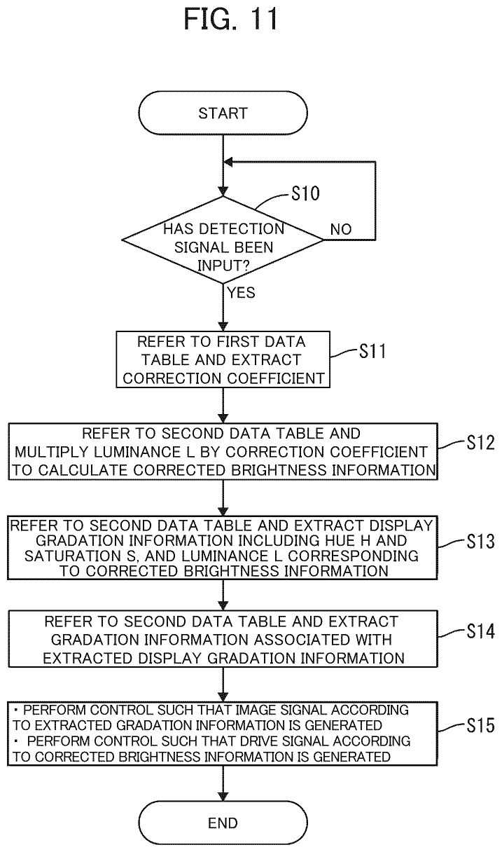

Specific correction processing to be performed by the controller 30 will be described with reference to FIG. 9 to FIG. 11. As illustrated in FIG. 11, the CPU 32 determines whether a detection signal has been input from the illuminance sensor 50 (step S10). When the determination result in step S10 is NO, the processing returns to step S10, and the CPU 32 determines again whether a detection signal has been input. When the determination result in step S10 is YES, the CPU 32 refers to the first data table DT1 in the memory 34 illustrated in FIG. 9 (step S11). Here, the first data table DT1 will be described. The first data table DT1 includes detection signals DS1 to DSN and correction coefficients C1 to CN associated with the detection signals DS1 to DSN, as illustrated in FIG. 9. Note that in FIG. 9, the numerals “1 to N” are added to the end of symbols for the detection signals DS1 to DSN and the correction coefficients C1 to CN respectively. Each of the numerals indicates the number of each symbol, where “N” is a natural number. In addition, the symbols given in the first data table DT1 are merely for convenience, and data actually written to the first data table DT1 may be changed as appropriate to symbols other than the symbols illustrated in FIG. 9. The numerical values of the correction coefficients C1 to CN are “1”, “a numerical value less than 1”, or “a numerical value greater than 1”. Correction coefficients with the numerical value “1” are associated with detection signals that are output when the amounts of ambient light detected by the illuminance sensor 50 are within a predetermined reference range. The reference range of the amount of ambient light is a range in which it is assumed that images can be viewed sufficiently without performing local dimming control when the images are displayed on the liquid crystal panel 11. Correction coefficients with “numerical values less than 1” are associated with detection signals that are output when the amounts of ambient light detected by the illuminance sensor 50 are less than a predetermined reference range. Correction coefficients with “numerical values greater than 1” are associated with detection signals that are output when the amounts of ambient light detected by the illuminance sensor 50 are greater than a predetermined reference range.

In step S11, the CPU 32 refers to the first data table DT1 illustrated in FIG. 9 and causes the correction unit 33 to extract a correction coefficient associated with the input detection signal, as illustrated in FIG. 11. Next, the CPU 32 refers to the second data table DT2 in the memory 34 illustrated in FIG. 10 (step S12). Here, the second data table DT2 will be described. The second data table DT2 includes gradation information (R1, G1, B1) to (RN, GN, BN), brightness information Br1 to BrN, display gradation information (r1, g1, b1) to (rN, gN, bN), and (h1, s1, l1) to (hN, sN, lN), as illustrated in FIG. 10. In this table, the display gradation information (r1, g1, b1) to (rN, gN, bN), and (h1, s1, l1) to (hN, sN, lN) represents numerical values in the RGB color space and HSL color space in an image actually displayed on the liquid crystal panel 11. More specifically, “r” in the display gradation information (r1, g1, b1) to (rN, gN, bN) represents a gradation value of red in the RGB color space in an image displayed on the liquid crystal panel 11, “g” represents a gradation value of green in the RGB color space in an image displayed on the liquid crystal panel 11, and “b” represents a gradation value of blue in the RGB color space in an image displayed on the liquid crystal panel 11. In addition, “h” in the display gradation information (h1, s1, l1) to (hN, sN, lN) represents a hue H (Hue) in the HSL color space in an image displayed on the liquid crystal panel 11, “s” represents a saturation S (Saturation) in the HSL color space in an image displayed on the liquid crystal panel 11, and “l” represents a luminance L (Lightness) in the HSL color space in an image displayed on the liquid crystal panel 11. The “R, G, B” columns in the display gradation information illustrated in FIG. 10 represent the RGB color space and the “H, S, L” columns represents the HSL color space.

The gradation information (R1, G1, B1) to (RN, GN, BN) illustrated in FIG. 10 represents gradation values of image signals that are applied to color unit pixels RPX, GPX, and BPX provided in the liquid crystal panel 11 via TFTs 20 and source wiring lines 23. More specifically, “R” in the gradation information (R1, G1, B1) to (RN, GN, BN) represents a gradation value of an image signal applied to a red pixel RPX, “G” represents a gradation value of an image signal applied to a green pixel GPX, and “B” represents a gradation value of an image signal applied to a blue pixel BPX. Brightness information Br1 to BrN represents brightness of each LED 15 provided in the backlight device 12. In the display gradation information (h1, s1, l1) to (hN, sN, lN), “l” corresponds to a luminance L in the HSL color space. Note that in FIG. 10, the numerals “1 to N” are added to the end of symbols for the gradation information (R1, G1, B1) to (RN, GN, BN) and display gradation information (r1, g1, b1) to (rN, gN, bN) and (h1, s1, l1) to (hN, sN, lN). Each of the numerals indicate the number of each symbol, where “N” is a natural number. Specifically, for 8-bit gradation, “N” is “256,” and there are approximately 16.77 million pieces of gradation information and approximately 16.77 million pieces of display gradation information. In addition, the symbols given in the second data table DT2 are merely for convenience, and data actually written to the second data table DT2 may be changed as appropriate to symbols other than the symbols illustrated in FIG. 10.

In step S12, the CPU 32 refers to the second data table DT2 and causes the correction unit 33 to multiply the luminance L included in the display gradation information by the correction coefficient to calculate corrected brightness information, as illustrated in FIG. 11. For example, as illustrated in FIG. 8, when the first area A1 is designated via the interface unit 40, the CPU 32 causes the correction unit 33 to multiply the luminance L in the display gradation information of an image displayed in the first area A1 by the correction coefficient to calculate corrected brightness information, but the CPU 32 does not cause the correction unit 33 to calculate corrected brightness information for an image displayed in the second area A2. Specifically, when the original display gradation information (processed video signal processed by the image processing unit 31) in the first area A1 has gradation values of (15, 143, 58) in the RGB color space (R, G, B), numerical values of (140, 207, 79) in the HSL color space (H, S, L), and a correction coefficient of “2”, the corrected brightness information value is “158”, which is twice the numerical value (79) of the luminance L. It should be noted that, as illustrated in FIG. 10, the gradation information associated with the original display gradation information is (RNa, GNb, BNc).

Next, the CPU 32 refers to the second data table DT2 and causes the correction unit 33 to extract, with respect to the first area A1, display gradation information that includes the hue H, the saturation S, and the luminance L that corresponds to the corrected brightness information, as illustrated in FIG. 11 (step S13). In the above-described example, display gradation information that has numerical values of (140, 207, 158) in the HSL color space (H, S, L) is extracted. Next, the CPU 32 refers to the second data table DT2 and causes the correction unit 33 to extract, with respect to the first area A1, gradation information associated with the extracted display gradation information (step S14). In the above-described example, the gradation information (RNd, GNe, BNf) associated with the display gradation information that has the numerical values of (140, 207, 158) in the HSL color space (H, S, L) in the second data table DT2 is extracted. Next, the CPU 32 controls the correction unit 33 such that the image signal generation unit 35 generates image signals according to the extracted gradation information and the drive signal generation unit 36 generates a drive signal according to the corrected brightness information (step S15).

Specifically, as illustrated in FIG. 8, the image signal generation unit 35 generates each image signal such that the gradation value of the image signal to be applied to the red pixels RPX disposed in the first area A1 is to be “RNd” that is included in the corrected display gradation information, the gradation value of the image signal to be applied to the green pixels GPX disposed in the first area A1 is to be “GNe” that is included in the corrected display gradation information, and the gradation value of the image signal to be applied to the blue pixels BPX disposed in the first area A1 is to be “BNf” that is included in the corrected display gradation information. On the other hand, the image signal generation unit 35 generates each image signal such that the gradation value of the image signal to be applied to the red pixels RPX disposed in the second area A2 is to be “RNa” that is included in the original (not corrected) display gradation information, the gradation value of the image signal to be applied to the green pixels GPX disposed in the second area A2 is to be “GNb” that is included in the original display gradation information, and the gradation value of the image signal to be applied to the blue pixels BPX disposed in the second area A2 is to be “BNc” that is included in the original display gradation information. As illustrated in FIG. 8, the drive signal generation unit 36 generates a PWM signal that has a duty ratio adjusted such that the corrected brightness information is to be provided as a drive signal to be supplied to first LEDs (first light sources) 15α that overlap the first area A1 among the plurality of LEDs 15. On the other hand, the drive signal generation unit 36 generates a PWM signal that has a duty ratio of the luminance L included in the original display gradation information, that is, brightness information that is not corrected, as a drive signal to be supplied to second LEDs (second light sources) 15β that overlap the second area A2 among the plurality of LEDs 15.

Here, in the above-described example, if output image data is generated by performing a predetermined luminance conversion process on input image data as in a known method, the corrected display gradation information has gradation values (25, 237, 96) in the RGB color space (R, G, B), and has numerical values (144, 217, 130) in the HSL color space (H, S, L). In other words, in the known luminance conversion processing, both of the hue H and the saturation S are different from those in the original display gradation information (hue H is 140, saturation S is 207), and thus colors in the image actually displayed are different from those in the original, resulting in poor display quality. In this embodiment, since both of the hue H and the saturation S in the corrected display gradation information match those in the original display gradation information, the colors in the image actually displayed become the original colors, thereby achieving high display quality.

As described above, the liquid crystal display device (display device) 10 according to the embodiment includes the liquid crystal panel (display panel) 11 that has the display surface 11DS, the driver (image display unit) 13 that displays an image on the display surface 11DS according to gradation information included in display gradation information (image data) supplied from an external source, the backlight device (illumination device) 12 that has the plurality of LEDs (light sources) 15 and emits light used for display to the liquid crystal panel 11, the LED drive circuit (light source drive unit) 19 that drives the plurality of LEDs 15 according to brightness information included in the display gradation information, the illuminance sensor 50 that detects ambient light and outputs a detection signal according to the amount of the detected ambient light, and the controller 30. The controller 30 corrects the brightness information according to the detection signal, controls the LED drive circuit 19 such that the plurality of LEDs 15 are driven according to the corrected brightness information, corrects the gradation information according to the detection signal, and controls the driver 13 such that an image is displayed according to the corrected gradation information.

When the illuminance sensor 50 detects ambient light, the illuminance sensor 50 outputs a detection signal according to the amount of detected ambient light. The controller 30 corrects the brightness information and the gradation information that are included in the display gradation information supplied from the external source according to the detection signal output from the illuminance sensor 50. Under the control of the controller 30, the LED drive circuit 19 drives the LEDs 15 according to the corrected brightness information. Under the control of the controller 30, the driver 13 displays an image on the display surface 11DS according to the corrected gradation information. As described above, since the detection signal detected by the illuminance sensor 50 is reflected in both of the amount of light emitted by the LEDs 15 in response to the drive by the LED drive circuit 19 and in the image displayed on the display surface 11DS, the actual display gradation in the image is closer to the original display gradation than in the known method. Accordingly, the increased display quality can be achieved.

The controller 30 may control the driver 13 such that the image is displayed according to the gradation information that is corrected, with respect to the first area A1 in the display surface 11DS, and the image is displayed according to the gradation information that is not corrected, with respect to the second area A2 other than the first area A1, and control the LED drive circuit 19 such that first LEDs (first light sources) 15α that overlap the first area A1 among the plurality of LEDs 15 are driven according to the brightness information that is corrected, and the second LEDs (second light sources) 15β other than the first LEDs 15α are driven according to the brightness information that is not corrected. For example, when the display surface 11DS includes an area in which important images are displayed, the area is defined as the first area A1 and an area in which images less important than those in the first area A1 are displayed is defined as the second area A2. In the first area A1, images according to gradation information that is corrected by the driver 13 are displayed and the first LEDs 15α that overlap the first area A1 are driven according to the brightness information that is corrected by the LED drive circuit 19. As a result, detection signals detected by the illuminance sensor 50 are reflected in the images displayed in the first area A1, thereby achieving increased visibility of important images. It should be noted that although detection signals detected by the illuminance sensor 50 are not reflected in the images displayed in the second area A2, these images are less important than the images displayed in the first area A1, and thus this is not a particular problem.

The controller 30 may include the correction unit 33 that corrects the brightness information and the gradation information, the drive signal generation unit 36 that generates a drive signal to drive the LEDs 15 according to the brightness information corrected by the correction unit 33 and outputs the drive signal to the LED drive circuit 19, and the image signal generation unit 35 that generates an image signal to display the image on the display surface 11DS according to the gradation information corrected by the correction unit 33 and outputs the image signal to the driver 13. The correction unit 33 corrects the brightness information and the gradation information that are included in the display gradation information according to the detection signal output from the illuminance sensor 50. The drive signal generation unit 36 generates a drive signal to drive the LEDs 15 according to the brightness information corrected by the correction unit 33 and outputs the generated drive signal to the LED drive circuit 19. The LED drive circuit 19 drives the LEDs 15 according to the drive signal output from the drive signal generation unit 36. The image signal generation unit 35 generates an image signal for displaying an image on the display surface 11DS according to the gradation information corrected by the correction unit 33 and outputs the generated image signal to the driver 13. The driver 13 displays the image on the display surface 11DS according to the image signal output from the image signal generation unit 35. Accordingly, since the controller 30 includes the correction unit 33, the drive signal generation unit 36, and the image signal generation unit 35, detection signals detected by the illuminance sensor 50 can be reflected in the amount of light emitted by the LEDs 15 and in images displayed on the display surface 11DS.

The controller 30 may include the memory 34 that stores the first data table DT1 including a plurality of correction coefficients related to the brightness information and a plurality of detection signals, the display gradation information, and the second data table DT2 including a plurality of pieces of gradation information and a plurality of pieces of brightness information. In the first data table DT1, the correction coefficients are associated with the detection signals, in the second data table DT2, the gradation information and the brightness information are associated with the display gradation information, the display gradation information includes hue H, saturation S, and luminance L in the HSL color space, and the brightness information corresponds to the luminance L. The controller 30 may refer to the first data table DT1 to extract the correction coefficient associated with the detection signal output from the illuminance sensor 50, multiply the brightness information by the extracted correction coefficient to correct the brightness information, refer to the second data table DT2 to extract the display gradation information including the hue H and the saturation S included in the display gradation information supplied from the external source and the luminance L corresponding to the corrected brightness information, as the corrected display gradation information, and extract the gradation information associated with the corrected display gradation information as the corrected gradation information. Accordingly, the controller 30 refers to the first data table DT1 and the second data table DT2 stored in the memory 34, thereby readily correcting the brightness information and the gradation information.

### Other Embodiments

The technology disclosed in this specification is not limited to the embodiment described above and illustrated in the drawings, but also includes, for example, the following embodiments within the scope of the technology.
(1) Without performing local dimming control, gradation information may be corrected according to detection signals from the illuminance sensor 50 across the entire display area AA, and images may be displayed according to the corrected gradation information.
(2) The specific size in plan view and the specific arrangement interval in plan view of the LEDs 15 may be changed as appropriate in addition to those illustrated in FIG. 3. The LEDs 15 may be mini-LEDs, micro-LEDs, or the like.
(3) In addition to the example illustrated in FIG. 5, a plurality of LEDs 15 may be disposed in one dimming area DA.
(4) The arrangement of unit pixels may be changed as appropriate in addition to that illustrated in FIG. 6.
(5) The specific electric configuration in the liquid crystal display device 10 may be changed as appropriate in addition to that illustrated in FIG. 7.
(6) The specific areas of the first area A1 and second area A2 and the specific numbers of the first LEDs 15α and the second LEDs 15β may be changed as appropriate in addition to those illustrated in FIG. 8. The specific number of the dimming areas DA included in the first area A1 and the second area A2 may be set to any number, and, for example, only one dimming area DA may be included in the first area A1.
(7) The specific description of the first data table DT1 may be changed as appropriate in addition to that illustrated in FIG. 9.
(8) The specific description of the second data table DT2 may be changed as appropriate in addition to that illustrated in FIG. 10.
(9) The specific processing procedure relating to the correction process to be performed by the correction unit 33 may be changed as appropriate in addition to that illustrated in FIG. 11.
(10) The colors provided by the unit pixels may include colors other than red, green, and blue (e.g., yellow, transparent, or other colors).
(11) The driver 13 may be mounted on the flexible substrate 14 by Chip On Film (COF) mounting.
(12) The planar shape of the liquid crystal panel 11 may be an elongated rectangle, square, circle, semicircle, elongated oval, ellipse, trapezoid, or other shapes.
(13) The liquid crystal display device 10 may be applicable to uses other than in-vehicle use.

The present disclosure contains subject matter related to that disclosed in Japanese Priority Patent Application JP 2024-206248 filed in the Japan Patent Office on Nov. 27, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel having a display surface;
an image display unit configured to display an image on the display surface according to gradation information included in image data supplied from an external source;
an illumination device having a plurality of light sources and is configured to emit light used for display to the display panel;
a light source drive unit configured to drive the plurality of light sources according to brightness information included in the image data;
an illuminance sensor configured to detect ambient light and output a detection signal according to the amount of detected ambient light; and
a controller, wherein
the controller corrects the brightness information according to the detection signal,
controls the light source drive unit such that the plurality of light sources are driven according to the corrected brightness information,
corrects the gradation information according to the detection signal, and
controls the image display unit such that an image is displayed according to the corrected gradation information.

2. The display device according to claim 1, wherein
the controller controls the image display unit such that the image is displayed according to the gradation information that is corrected, with respect to a first area in the display surface, and the image is displayed according to the gradation information that is not corrected, with respect to a second area other than the first area, and
controls the light source drive unit such that first light sources that overlap the first area among the plurality of light sources are driven according to the brightness information that is corrected, and second light sources other than the first light sources are driven according to the brightness information that is not corrected.

3. The display device according to claim 1, wherein
the controller includes
a correction unit configured to correct the brightness information and the gradation information,
a drive signal generation unit configured to generate a drive signal to drive the light sources according to the brightness information corrected by the correction unit and output the drive signal to the light source drive unit, and
an image signal generation unit configured to generate an image signal to display the image on the display surface according to the gradation information corrected by the correction unit and output the image signal to the image display unit.

4. The display device according to claim 1, wherein
the controller includes
memory that stores a first data table including a plurality of correction coefficients related to the brightness information and a plurality of detection signals, the image data, and a second data table including a plurality of pieces of gradation information and a plurality of pieces of brightness information,
in the first data table, the correction coefficients are associated with the detection signals,
in the second data table, the gradation information and the brightness information are associated with the image data, the image data includes hue H, saturation S, and luminance L in the HSL color space, and the brightness information corresponds to the luminance L,
the controller refers to the first data table to extract the correction coefficient associated with the detection signal output from the illuminance sensor,
multiplies the brightness information by the extracted correction coefficient to correct the brightness information,
refers to the second data table to extract the image data including the hue H and the saturation S included in the image data supplied from the external source and the luminance L corresponding to the corrected brightness information, as the corrected image data, and
extracts the gradation information associated with the corrected image data as the corrected gradation information.
